(19) United States
(12) Patent Application Publication
(10) Pub. No.: US 2003/0018909 A1
(43) Pub. Date: Jan. 23, 2003

(54) Method and apparatus for enforcing security policies in Java applications

(75) Inventors: Gennaro A. Cuomo, Apex, NC (US); Matt Richard Hogstrom, Apex, NC (US); Nataraj Nagaratnam, Morrisville, NC (US)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 09/907,848

(22) Filed: Jul. 17, 2001

(51) Int. Cl. G06F 11/30

(52) U.S. Cl. 713/200

(57) ABSTRACT

A method, apparatus, and computer implemented instructions for enforcing security policies in a data processing system. In response to loading a class, a determination is made as to whether a security policy exists for the class. In the depicted examples, the class is a Java. Code is inserted into the class, wherein the code inserted is based on the policy in response to a determination that a security policy exists for the class.

### FIELD OF THE INVENTION

The present invention relates generally to an improved data processing system, and in particular to a method and apparatus for managing applications in a data processing system. Still more particularly, the present invention provides a method, apparatus, and computer implemented instructions for enforcing security policies for security unaware applications in a data processing system.

### BACKGROUND OF THE INVENTION

Securing applications is an important process in any computing environment. Security policies may be specified at different levels, such as at a method level. In specifying a security policy at a method level, the policy may be specified from where the code is loaded, by who developed or signed the code, and/or which subject is invoking the operation of the code. Most security policies are enforced either by a security aware application or by an underlying system in which applications execute.

For example, in a Java programming system, the security subsystem in a standard Java virtual machine (JVM) will check access to system resources based on the specified security policies. JDK is a Java software development environment from Sun Microsystems, Inc. JDK includes the JVM, compiler, debugger and other tools for developing Java applets and applications. The system resources for which access may be controlled, include, for example, files and sockets. With application level resource access, a requirement is present for the application to be security aware such that the application checks the required permission before granting access to a resource. For example, before granting access to any method on a Java object of type “Account”, the application should ask the security manager component to perform a check whether the invoking principal (or code) has been granted the “AccountPermission”. Currently, applications either use standard security application programming interfaces (APIs) to perform security checks on access to application resources or use the policy mechanism to control access to system resources.

Java 2 platform Enterprise Edition (J2EE) addresses the aspects of security as described above so long as the applications adhere to an enterprise Java bean (EJB) or servlet/Java server page (JSP) programming model. J2EE is a platform available from Sun Microsystems, Inc. for building enterprise applications. J2 EE services are performed in the middle tier between the user's browser and the enterprise's databases and legacy information systems. J2EE comprises a specification, reference implementation and set of testing suites. The core component is EJBs, followed by JSPs and Java servlets, and a variety of interfaces for linking to the information resources in the enterprise. J2EE specifies a mechanism by which security policies on EJBs, JSP files, and servlets can be declaratively defined in an environment without affecting application code.

Even with this type of programming system, many applications are present that do not satisfy the criteria with respect to the EJB or servlet/JSP programming model. These applications are often developed in a proprietary manner using standalone Java objects that accesses business data. It is desirable to secure such applications and objects in a manner transparent to the applications and still provide a level of granularity still defined within the scope of the application.

Therefore, it would be advantageous to have an improved method and apparatus for enforcing security policies to security unaware applications.

### SUMMARY OF THE INVENTION

The present invention provides a method, apparatus, and computer implemented instructions for enforcing security policies in a data processing system. In response to loading a class, a determination is made as to whether a security policy exists for the class. In the depicted examples, the class is a Java. Code is inserted into the class, wherein the code inserted is based on the policy in response to a determination that a security policy exists for the class.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram that illustrates the relationship of software components operating within a computer system that may implement the present invention;

FIG. 4 is a block diagram of a JVM in accordance with a preferred embodiment of the present invention;

FIG. 5 is a diagram of code illustrating a security policy in accordance with a preferred embodiment of the present invention;

FIGS. 6A and 6B are diagrams illustrating enforcement of a security policy in accordance with a preferred embodiment of the present invention; and

FIG. 7 is a flowchart of a process used for enforcing policies in accordance with a preferred embodiment of the present invention.

### DETAILED DESCRIPTION OF THE PREFERRED EMBODIMENT

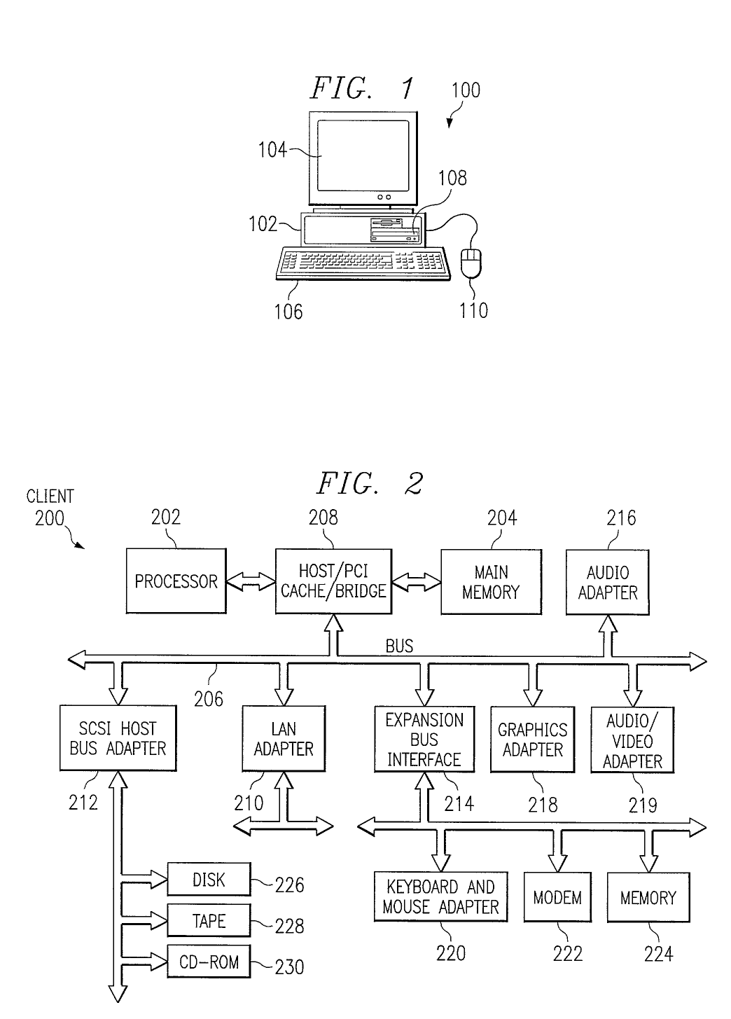

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

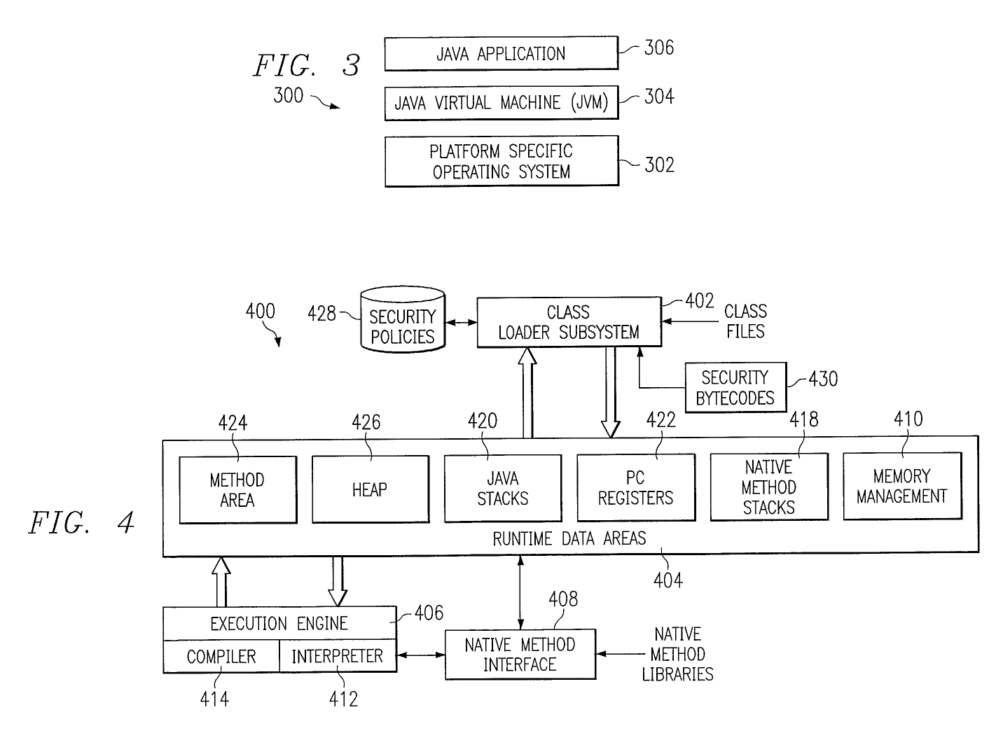

With reference now to FIG. 3, a block diagram illustrates the relationship of software components operating within a computer system that may implement the present invention. Java-based environment 300 contains platform specific operating system 302 that provides hardware and system support to software executing on a specific hardware platform. Java virtual machine (JVM) 304 is one software application that may execute in conjunction with the operating system. JVM 304 provides a Java run-time environment with the ability to execute Java application or applet 306, which is a program, servlet, or software component written in the Java programming language. The computer system in which JVM 304 operates may be similar to data processing system 200 in FIG. 2 or computer 100 in FIG. 1 described above. However, JVM 304 may be implemented in dedicated hardware on a so-called Java chip, Java-on-silicon, or Java processor with an embedded picoJava core.

At the center of a Java run-time environment is the JVM, which supports all aspects of Java's environment, including its architecture, security features, mobility across networks, and platform independence.

The present invention provides a method, apparatus, and computer implemented instructions for executing security unaware applications in a security aware infrastructure, such as JVM 304, without modifying the developed code but enforcing the policies specified separately. In the depicted examples, these policies may be specified at a method level and as a set of required permissions. In this manner, an effective security policy may be enforced during runtime.

The JVM is a virtual computer, i.e. a computer that is specified abstractly. The specification defines certain features that every JVM must implement, with some range of design choices that may depend upon the platform on which the JVM is designed to execute. For example, all JVMs must execute Java bytecodes and may use a range of techniques to execute the instructions represented by the bytecodes.

Java programs are not run directly by the central processor but instead by the JVM, which is itself a piece of software running on the processor. The JVM allows Java programs to be executed on a different platform as opposed to only the one platform for which the code was compiled. Java programs are compiled for the JVM. To enable a Java application to execute on different types of data processing systems, a compiler typically generates an architecture-neutral file format—the compiled code is executable on many processors, given the presence of the Java run-time system. The Java compiler generates bytecode instructions that are nonspecific to a particular computer architecture. A bytecode is a machine independent code generated by the Java compiler and executed by a Java interpreter. A Java interpreter is part of the JVM that alternately decodes and interprets a bytecode or bytecodes. These bytecode instructions are designed to be easy to interpret on any computer and easily translated on the fly into native machine code.

With reference now to FIG. 4, a block diagram of a JVM is depicted in accordance with a preferred embodiment of the present invention. JVM 400 is an example of an environment in which the mechanism of the present invention may be implemented.

In these examples, JVM 400 includes class loader subsystem 402, which is a mechanism for loading types, such as classes and interfaces. JVM 400 also contains runtime data areas 404, execution engine 406, native method interface 408, and memory management 410. Execution engine 406 is a mechanism for executing instructions contained in the methods of classes loaded by class loader subsystem 402. Execution engine 406 may be, for example, Java interpreter 412 or just-in-time compiler 414. Native method interface 408 allows access to resources in the underlying operating system. Native method interface 408 may be, for example, a Java native interface.

Runtime data areas 404 contain native method stacks 418, Java stacks 420, PC registers 422, method area 424, and heap 426. These different data areas represent the organization of memory needed by JVM 400 to execute a program.

Java stacks 420 are used to store the state of Java method invocations. Program counter (PC) registers 422 are used to indicate the next instruction to be executed. Each instantiated thread gets its own PC register and Java stack. If the thread is executing a JVM method, the value of the PC register indicates the next instruction to execute. If the thread is executing a native method, then the contents of the PC register are undefined.

Native method stacks 418 stores the state of invocations of native methods. The state of native method invocations is stored in an implementation-dependent way in native method stacks, registers, or other implementation-dependent memory areas. In some JVM implementations, native method stacks 418 and Java stacks 420 are combined.

Method area 424 contains class data while heap 426 contains all instantiated objects. Most JVMs choose to have one method area and one heap, each of which are shared by all threads running inside the JVM. When the JVM loads a class file, it parses information about a type from the binary data contained in the class file. It places this type information into the method area. Each time a class instance or array is created, the memory for the new object is allocated from heap 426. JVM 400 includes an instruction that allocates memory space within the memory for heap 426 but includes no instruction for freeing that space within the memory. Memory management 410 in the depicted example manages memory space within the memory allocated to heap 426. Memory management 410 may include a garbage collector, which automatically reclaims memory used by objects that are no longer referenced. Additionally, a garbage collector also may move objects to reduce heap fragmentation.

In particular, the processes of the present invention may be applied to class loader subsystem 402. When loading class files, class loader subsystem 402 may check security policies 428 to determine whether a class file requires enforcement of a security policy. Class loader subsystem 402 does not care whether the application is security unaware. Class loader subsystem 402 will insert the bytecodes based on the security policies specified based on the invention irrespective of whether the application is security aware or not. Even if the application is security aware, ∓additional” security policies can be specified based on the invention. The security policies within security policies 428 may be specified using policy files.

If a policy is specified based on the mechanism of the present invention, the mechanism performs a security check on the application level resource, the appropriate set of bytecodes may be selected from security bytecodes 430 and statically inserted into the bytecodes for the class file being loaded. In this manner, security checks may be added after an application is developed. Such a mechanism is useful for security operations, such as, for example, authorization checks and auditing. Based on the external requirements, classes that are not identified as being inspectable may have their class loading terminating with an appropriate exception.

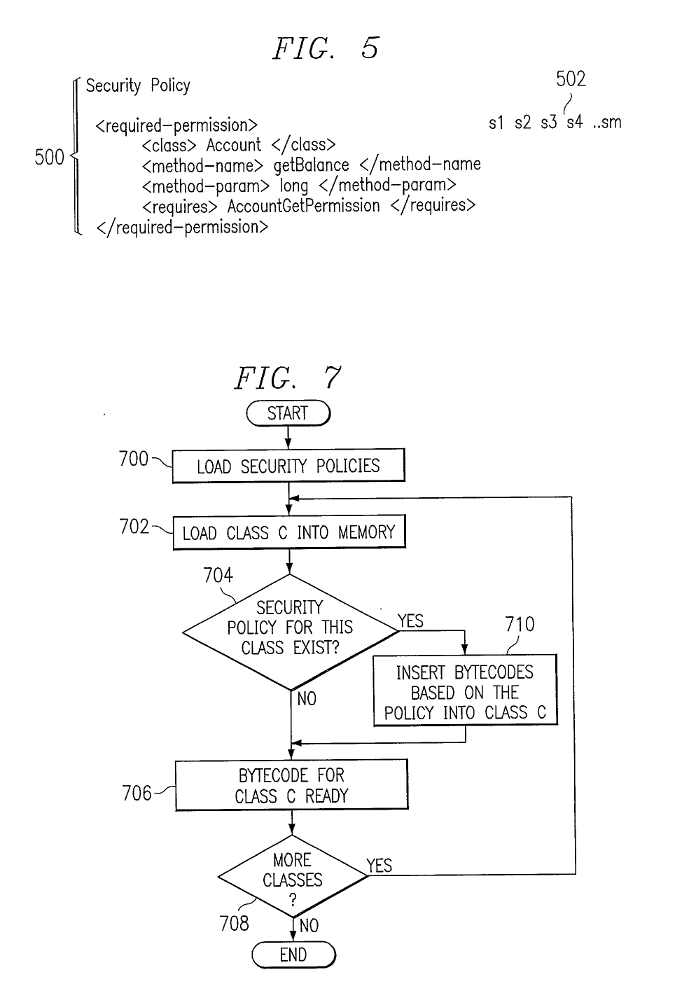

Turning next to FIG. 5, a diagram of code illustrating a security policy is depicted in accordance with a preferred embodiment of the present invention. Security policy 500 is an example of a security policy that may be found within security policies 428 in FIG. 4 for use in dictating security policies. In the depicted examples, security policy 500 dictates an authorization security policy for a class Account with a method getBalance, indicating that permission must be obtained to invoke the method getBalance. Line 502 is an example of bytecodes for implementing this security check.

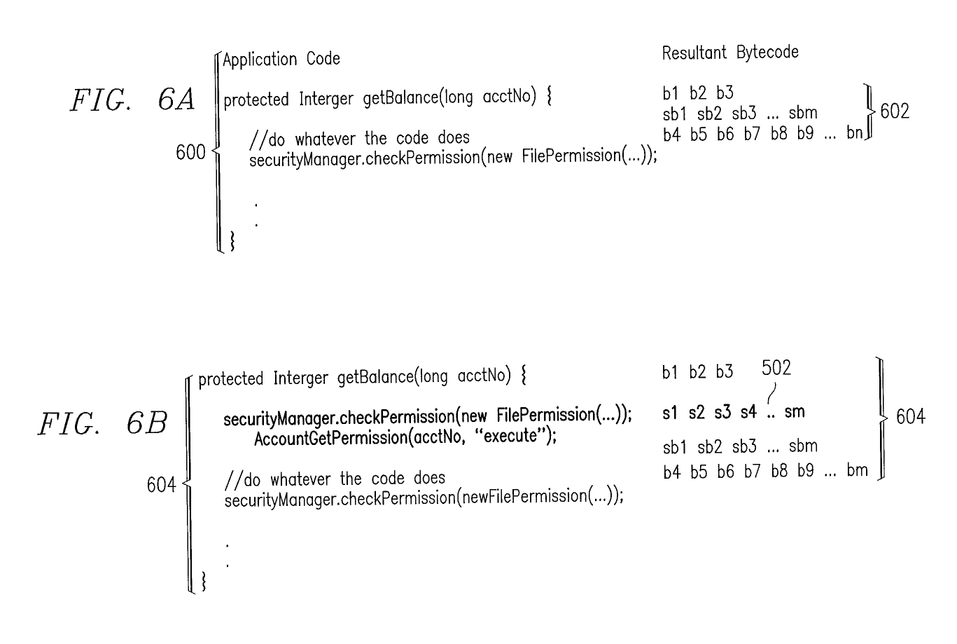

Turning next to FIGS. 6A and 6B, diagrams illustrating enforcement of a security policy are depicted in accordance with a preferred embodiment of the present invention. Security policy 500 in FIG. 5 may be added to application code 600, in FIG. 6A if security checks are to be included for the class name of the class being loaded in application code 600. In this example, application code 600 is a security aware code. Additional security checks, however, may be added or security checks may be changed using the mechanism of the present invention.

Resultant bytecodes 602 are bytecodes resulting from application code 600. Security policy 500 in FIG. 5 is converted to a resultant bytecode in line 502. These bytecodes are inserted into resultant bytecode 602 to result in bytecode 604 in FIG. 6B. Modified application code 604 includes additional lines for security policy 500. Therefore, the analysis that takes place in these examples is whether a policy exists for the class name of the class that gets loaded. If a policy exists, then the appropriate bytecodes are inserted into the class that is loaded.

Turning now to FIG. 7, a flowchart of a process used for enforcing policies is depicted in accordance with a preferred embodiment of the present invention. The process illustrated in FIG. 7 may be implemented in a class loader, such as class loader subsystem 402 in FIG. 4.

The process begins by loading security policies (step 700). Next, a class is loaded into a memory (step 702). A determination is then made as to whether a security policy for this class exists (step 704). This determination may be made by analyzing the policy file and seeing if the class name is present in any of the policies. If no security policy for this code exists, the bytecode for the class is ready for execution (step 706). Then, a determination is made as to whether more classes are present for processing (step 708). If there are no more classes, the process terminates. Otherwise the process returns to step 702 as described above. Turning back to step 704, if a security policy for this class does exist, bytecodes are inserted into the class based on policy (step 710) with the proceeding to step 706 as described above.

Thus, the present invention provides a method, apparatus, and computer implemented instructions for enforcing security policies for security unaware applications. The mechanism of the present invention enforces security policies by inserting bytecodes into the classes. This mechanism does not require applications to be security aware. In these examples, if the application is security aware, the invention does help declaratively by adding more security checks after code development time to be enforced during class loading time. Further, through this mechanism security policies may be configured after development of the applications. This mechanism also may be employed to extend the policy based infrastructure in current environments to require permissions even in the case of normal security aware applications. In this manner, a finer granularity of control over class method is made available.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. In the depicted examples, Java applications are illustrated as application in which bytecodes are inserted into loaded classes to enforce policies. The mechanism of the present invention may be applied to other types of applications other than Java applications and to other types of non-specific code other than bytecodes. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for enforcing security policies, the method comprising:
responsive to loading a class, determining whether a security policy exists for the class; and
responsive to a determination that a security policy exists for the class, inserting code into the class, wherein the code inserted is based on the security policy.

2. The method of claim 1, wherein the code is a set of bytecodes.

3. The method of claim 1, wherein the class is a Java class.

4. The method of claim 1, wherein the determining step and the inserting step are performed in a class loader.

5. The method of claim 1, wherein the class is code nonspecific to the data processing system.

6. The method of claim 1, wherein the code is for a security check.

7. The method of claim 1 further comprising:
loading the class into a memory.

8. A method in a data processing system for enforcing security policies, the method comprising:
analyzing a set of bytecodes for a class loaded into memory to form an analysis; and
selectively inserting bytecodes for a security check into the set of bytecodes based on the analysis.

9. The method of claim 8, wherein the class is a Java class.

10. The method of claim 8, wherein the analyzing step comprises:
comparing a class name of the class being loaded to the classes for which security policies exist.

11. A data processing system comprising:
a bus system;
a communications unit connected to the bus system;
a memory connected to the bus system, wherein the memory includes a set of instructions; and
a processing unit connected to the bus system, wherein the processing unit executes the set of instructions to determine whether a security policy exists for a class in response to loading the class; and insert code into the class, wherein the code inserted is based on the policy in response to a determination that a security policy exists for the class.

12. The data processing system of claim 11, wherein the bus system is a single bus.

13. The data processing system of claim 11, wherein the bus system includes a primary bus and a secondary bus.

14. The data processing system of claim 11, wherein the processing unit includes a plurality of processors.

15. The data processing system of claim 11, wherein the communications unit is one of a modem and Ethernet adapter.

16. A data processing system comprising:
a bus system;
a communications unit connected to the bus system;
a memory connected to the bus system, wherein the memory includes a set of instructions; and
a processing unit connected to the bus system, wherein the processing unit executes the set of instructions to analyze a set of bytecodes for a class loaded into memory to form an analysis; and selectively insert bytecodes for a security check into the set of bytecodes based on the analysis.

17. The data processing system of claim 16, wherein the bus system is a single bus.

18. The data processing system of claim 16, wherein the bus system includes a primary bus and a secondary bus.

19. The data processing system of claim 16, wherein the processing unit includes a plurality of processors.

20. The data processing system of claim 16, wherein the communications unit is one of a modem and Ethernet adapter.

21. A data processing system for enforcing security policies, the data processing system comprising:
determining means, responsive to loading a class, for determining whether a security policy exists for the class; and
inserting means, responsive to a determination that a security policy exists for the class, for inserting code into the class, wherein the code inserted is based on the security policy.

22. The data processing system of claim 21, wherein the code is a set of bytecodes.

23. The data processing system of claim 21, wherein the class is a Java class.

24. The data processing system of claim 21, wherein the determining means and the inserting means are located in a class loader.

25. The data processing system of claim 21, wherein the class is nonspecific code.

26. The data processing system of claim 21, wherein the code is for a security check.

27. The data processing system of claim 21 further comprising:
loading means for loading the class into a memory.

28. A data processing system for enforcing security policies, the data processing system comprising:
analyzing means for analyzing a set of bytecodes for a class loaded into memory to form an analysis; and
inserting means for selectively inserting bytecodes for a security check into the set of bytecodes based on the analysis.

29. The data processing system of claim 28, wherein the class is a Java class.

30. The data processing system of claim 28, wherein the analyzing means comprises:
means for comparing at least a portion of the bytecodes to a set of security policies.

31. A computer program product in a computer readable medium for enforcing security policies, the computer program product comprising:
first instructions, responsive to loading a class, for determining whether a security policy exists for the class; and
second instructions, responsive to a determination that a security policy exists for the class, for inserting code into the class, wherein the code inserted is based on the security policy.

32. The computer program product of claim 31, wherein the code is a set of bytecodes.

33. The computer program product of claim 31, wherein the class is a Java class.

34. The computer program product of claim 31, wherein the first instructions and the second instruction are located in a class loader.

35. The computer program product of claim 31, wherein the class is nonspecific code.

36. The computer program product of claim 31, wherein the code is for a security check.

37. The computer program product of claim 31 further comprising:
third instructions for loading the class into a memory.

38. A computer program product in a computer readable medium for enforcing security policies, the computer program product comprising:
first instructions for analyzing a set of bytecodes for a class loaded into memory to form an analysis; and
second instructions for selectively inserting bytecodes for a security check into the set of bytecodes based on the analysis.

39. The computer program product of claim 38, wherein the class is a Java class.

40. The computer program product of claim 38, wherein the first instructions comprises:
sub-instructions comparing at least a portion of the bytecodes to a set of security policies.
